(19) United States
(12) Patent Application Publication
(10) Pub. No.: US 2005/0218266 A1
(43) Pub. Date: Oct. 6, 2005

(54) Avionic door lock system

(76) Inventors: Paul W. Bandy, Kent, WA (US); Darrell W. Gaston JR., Everett, WA (US); Binh C. Truong, Kirkland, WA (US); Dwight R. Schaeffer, Mercer Island, WA (US); Shannon J. Kupfer, Kirkland, WA (US); Steven D. Flickinger, Arlington, WA (US); Steven L. Wehr, Everett, WA (US); James J. Johnson, Snohomish, WA (US); Julie M. Shinn, Mukilteo, WA (US); Mark E. Smith, Renton, WA (US)

Correspondence Address: HARNESS, DICKEY & PIERCE, P.L.C., P.O. BOX 828, BLOOMFIELD HILLS, MI, 48303, US

(21) Appl. No.: 11/128,809

(22) Filed: May 13, 2005

Related U.S. Application Data
(63) Continuation-in-part of application No. 10/100,227, filed on Mar. 18, 2002.

(51) Int. Cl. B64D 11/00

(52) U.S. Cl. 244/118.5

(57) ABSTRACT

A security system adapted for use on an aircraft to prevent unauthorized access into a cockpit area of the aircraft via a cockpit door. The system includes a keypad accessible by individuals in a cabin area of the aircraft. A logic system is in communication with the keypad and also with a switch disposed inside the cockpit. Occupants of the cockpit, via the switch, have the ability to manually unlock the cockpit door, to deny the request for entry, or to do nothing, in which case the door will be automatically unlocked after the expiration of a predetermined time interval. The switch further provides a cut-off switch which enables the power to be removed from the system if necessary. In addition, a display system may be employed to notify the occupants of the cockpit that entry into the cockpit has been requested.

### CROSS-REFERENCE TO RELATED APPLICATIONS

This application is a continuation-in-part of U.S. patent application Ser. No. 10/100,227, filed on Mar. 18, 2002, the disclosure of which is incorporated herein by reference.

### FIELD OF THE INVENTION

This invention relates to security systems, and more particularly to a security system adapted for use on a mobile platform for preventing unauthorized entry into the cockpit of an aircraft.

### BACKGROUND OF THE INVENTION

At the present time there is an increasing need for controlling access to particular areas of mobile platforms. More specifically, there is an increasing need to control access to a cockpit of a commercial aircraft. Present day security systems often involve a simple lock or other system requiring the use of a key to unlock a door leading to a cockpit. However, such systems can be inconvenient for flight attendants who may need to periodically enter the cockpit area of an aircraft, such systems require a low force to open the door in case of a decompression event.

Present day systems for preventing unauthorized access to the cockpit of a commercial aircraft through the use of a key can be forced open, and also can be foiled by an intruder if the intruder should gain access to the key. Accordingly, there is a strong need for a security system for preventing unauthorized access into a cockpit of a commercial aircraft which does not suffer from the above-described limitations.

More specifically, there is a need for a security system for use on a commercial aircraft which provides the pilot, co-pilot or other occupants of the cockpit a signal that entry into the cockpit is being requested. Such a system would ideally give the individuals in the cockpit an opportunity to make an assessment as to whether or not entry into the cockpit will be permitted immediately, or whether entry should be denied. There is further a need for such a system which allows the pilot, co-pilot or other cockpit occupant to unlock the door separating the cockpit from the cabin area of the aircraft from a convenient location within the cockpit. Also required is the ability for the flight attendant to unlock the door after alerting the pilot and co-pilot for a pre-set time, in case the pilot and co-pilot are unable to perform the needed operation to unlock the door.

### SUMMARY OF THE INVENTION

The above and other objects are provided by a security system in accordance with preferred embodiments of the present invention. The security system is particularly well adapted for use in mobile platforms such as, but not limited to, commercial aircraft. In one embodiment, the security system operates to lock a door which separates a cockpit from a passenger cabin area, and to allow occupants of the cockpit to receive signals indicating that a request for entry into the cockpit has been made by an individual in the passenger cabin area. The system further enables an occupant of the cockpit to provide a signal to the system allowing immediate unlocking of the cockpit door, or to deny the request to unlock the door.

The system in one preferred form includes a user input device which is accessible by individuals in the cabin area. The input device may comprise a keypad. A controller incorporating an audible component is disposed in the cockpit. The logic system communicates with a control device positioned for convenient use by persons in the cockpit, as well as with a lock operably associated with the cockpit door. In one preferred form the control device comprises a multi-position rotary switch.

In a preferred embodiment the multi position rotary switch provides three switch positions: an “AUTO” position, an “UNLOCK” position and a “DENY” position. An individual in the cabin area makes a request to gain entry to the cockpit by entering a predetermined access code into the keypad. It will be appreciated that the access code is a pre-programmed, restricted code that only individuals, such as flight attendants, would be apprised of in advance of entering the aircraft. When a correct access code is input to the keypad, the logic system generates an aural and visual annunciation within the cockpit apprising individuals in the cockpit that a request to enter the cockpit has been made.

If the switch is in the AUTO position, the occupants of the cockpit have a predetermined time period in which to decide either to unlock the cockpit door or to deny the request to enter. If a decision is made to allow entry, the occupants may leave the switch in the AUTO position, in which case the logic system will automatically unlock the lock associated with the cockpit door at the expiration of the predetermined time interval. If the occupants decide that entry should not be permitted, then the switch can be moved to the DENY position. This signals the logic system that the request to enter is being denied. The logic system will immediately disable the keypad and prevent further entry signals from being generated within the cockpit for a predetermined time thereafter.

If the occupants decide to grant immediate entry, then moving the switch to the UNLOCKED position sends a signal to the logic system that the lock to the cockpit door should be immediately unlocked. The logic system then sends a signal to a suitable device, such as a solenoid, that immediately unlocks the cockpit door. The UNLOCK position unlocks the door at any time and stops all ongoing visual and aural annunciations.

In one preferred embodiment the signal provided by the logic system is provided by a chime associated with a controller. The logic system also implements an intelligent series of time delays after a request for entry has been made at the keypad. When such a request has been made, the controller causes the chime to emit an audible signal to the occupants of the cockpit. The controller also simultaneously begins a first predetermined delay interval. If no action has been taken at the control device by any occupant of the cockpit at the expiration of the first predetermined delay interval, a second audible warning is provided by the chime and a second predetermined delay interval is commenced.

At the end of the second predetermined delay interval, if still no action has been taken by any occupant via the switch to either admit or deny the request for entry, then the chime provides a continuous audible warning for a third predetermined time delay interval. At the end of the third delay interval the controller automatically sends a signal to the solenoid to unlock the lock to the cockpit door. A visual indicator also preferably flashes intermittently during the third delay interval further signaling that the cockpit door will be unlocked within a very short time if no action is taken.

This operating scheme thus provides a short time period for the occupants of the cockpit to make an assessment as to whether the request for entry to the cockpit should be granted or denied. Conveniently, the door lock is automatically unlocked without intervention by the occupants of the cockpit provided the control device is in the AUTO position. The provision of both audible and visual signals virtually eliminates the possibility that the occupants of the cockpit will not realize that a request for entry has been made. It further allows automatic unlocking of the cockpit door unless an occupant of the cockpit intervenes through appropriate control of the switch. The switch also provides a cut-off feature to remove power to the lock, if necessary.

It will be appreciated that the keypad described above does not have the capability under any circumstances to unlock the door lock of the cockpit door. The lock is controlled strictly by signals received from the controller and a pressure sensor provided in the cockpit. Accordingly, no amount of tampering with the keypad, or even the destruction of the keypad, can result in unlocking of the cockpit door once it is locked.

Further, the present invention could also include a display system in communication with the controller to display at least one of a visual indicator or message announcing that entry to the cockpit has been requested. Generally, the display system may include left, right and central multi-function displays which are capable of displaying at least one of a message or visual indicator to the occupants of the cockpit. Thus, the display system may provide an additional or alternative method for notifying the occupants in the cockpit that entry into the cockpit has been requested.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a detailed schematic of a security system 10 in accordance with a preferred embodiment of the present invention;

FIG. 1a is a simplified schematic of the security system of FIG. 1;

FIG. 2 is a timeline of the three time delay intervals implemented by the controller of the system after a request to unlock the cockpit door is received; and

FIG. 3 is an environmental view of an alternate embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

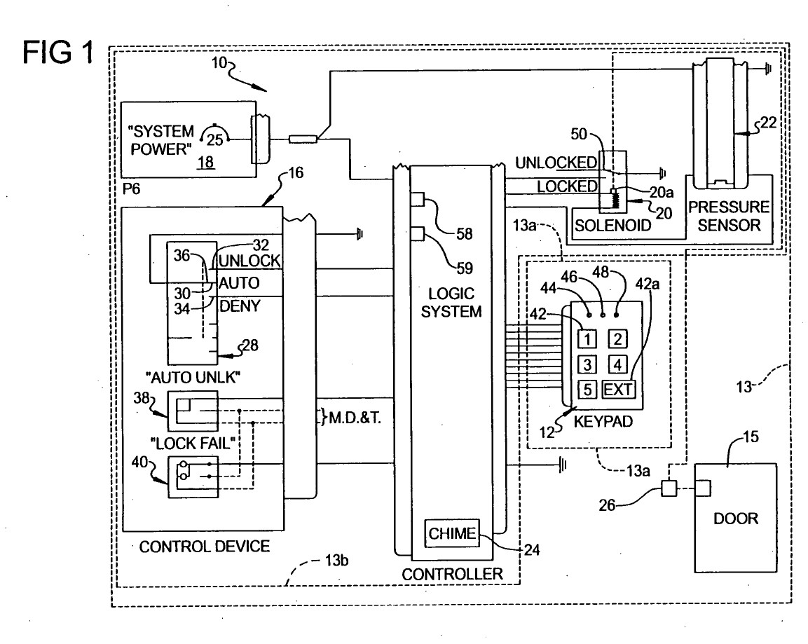

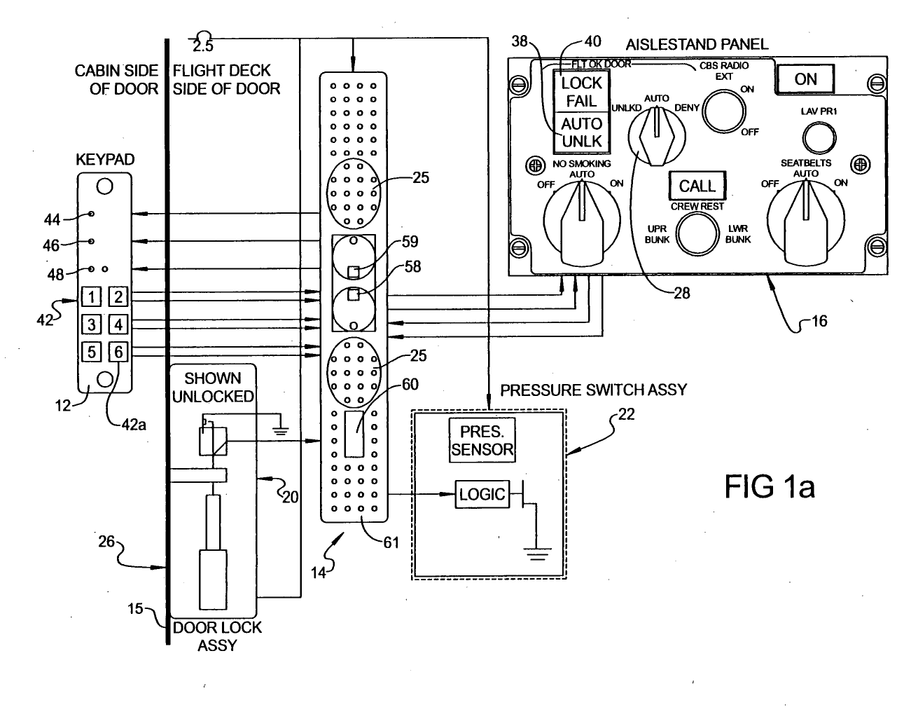

Referring to FIG. 1, there is shown a security system 10 for controlling access into a control center of a mobile platform. In the following description, the mobile platform will be referred to as a commercial aircraft and the control center will be referred to as the cockpit of the aircraft. It will be appreciated, however, that the system 10 of the present invention is equally applicable to non-moving structures where it is desired to closely control access to a sensitive area of the structure. It is anticipated that the invention may also find applications on other mobile platforms such as ships, trains or even buses. The system 10 advantageously includes only a limited number of independent component parts making it easily retrofitable to existing commercial or other types of aircraft.

Referring further to FIGS. 1 and 1a, the system 10 generally includes a user input device in the form of a keypad 12 which is disposed in the passenger cabin area 13a of an aircraft 13, and in one preferred location on a door post assembly 15a adjacent a door 15 of the aircraft 13 facing the passenger cabin area. However, the keypad 12 may be placed in virtually any location where it can be conveniently accessed by flight crew members who may need to gain periodic access to the cockpit 13b of the aircraft 13.

The keypad 12 is in communication with a logic system 14. The logic system 14, in turn, is in communication with a control device 16, a circuit breaker 18 and a door lock solenoid 20. An ambient air pressure sensor 22 disposed in a cockpit 13b of the aircraft 13 communicates with the door lock solenoid 20 and the logic system 14. The door lock solenoid 20 is operably associated with a door lock 26 for the cockpit door 15, as will be described in greater detail below.

The logic system 14 comprises a suitable controller, and more preferably an 8-bit controller. Advantageously, the controller 14 includes a chime 24 which is used to generate an audible signal which is emitted through speakers 25 disposed in the cockpit 13b of the aircraft 13. The control device 16 is also disposed in the cockpit 13b and may be mounted on an overhead panel, in an aisle stand panel or at any other conveniently accessible location in the cockpit 13b.

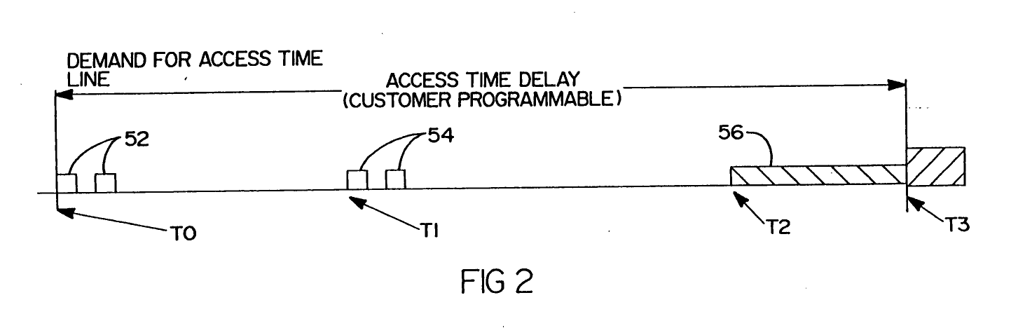

With continuing reference to FIGS. 1 and 1a, and additional reference to FIG. 2, the control device 16 includes a multi position rotary switch 28 having a first switch position 30 designated as the “AUTO” position, a second switch position 32 designated the “UNLOCK” position and a third switch position 34 designated as the “DENY” position. The switch 28 comprises a manually engageable switch element 36 which is spring biased normally into the AUTO position. The switch element 36 can be moved momentarily into either the UNLOCK position or the DENY position. As soon as the switch element 36 is released, however, it is biased back to the AUTO position. An “AUTO UNLK” indicator light 38 is also disposed closely adjacent the switch 28, as is a “LOCK FAILED” indicator light 40. The “AUTO UNLK” indicator light 38 is illuminated when a predetermined access code has been correctly entered into the keypad 12, as will be described in greater detail below. The LOCK FAILED indicator light 40 indicates that the solenoid 20 has received a signal from the logic system 14 to lock the door lock 26 of the cockpit door 15, but the door lock 26 is not in the locked position.

In addition, the controller 14 may also include a cut-off switch 60. The cut-off switch 60 is in communication with the circuit breaker 18 and the logic system 14. In particular, the cut-off switch 60 is in communication with the chime 24 of the logic system 14 to enable the occupants of the cockpit 13b to interrupt the flow of current from the circuit breaker 18 to the chime 24 in the case of a failure of the chime 24. Thus, in a case where the chime 24 malfunctions, the occupants of the cockpit 13b can toggle the cut-off switch 60 into the “OFF” position, and the chime 24 will be de-energized and power will be removed from the solenoid 20. When the chime 24 is operational, the cut-off switch 60 will be toggled into an “ON” position.

The keypad 12 comprises a plurality of numeric keys 42 and an “ENTER” key 42a, a first indicator light 44, a second indicator light 46 and a third indicator light 48. The first indicator light 44 preferably comprises a red LED for indicating that the system 10 has power for operation. A second indicator light 46 preferably comprises an amber LED which is illuminated when a user inputs the predetermined access code correctly via the keys 42 and 42a. Third indicator light 48 preferably comprises a green LED which signals that the solenoid 20 has unlocked the door lock 26.

The solenoid 20 includes a microswitch 50 for sensing the position of a plunger 20a of the solenoid 20. Accordingly, the controller 14 can verify that the plunger 20a has been moved into the locked position when the solenoid 20 is energized. This provides an additional degree of security in the event the solenoid 20 fails and the plunger 20a is not moved into the “LOCKED” position. In such instance, the LOCK FAILED indicator light 40 will be illuminated by the controller 14 to provide an immediate visual indication of such a condition to the occupants of the cockpit 13b.

With continuing reference to FIGS. 1, 1a and 2, the ambient air pressure sensor 22 is used to detect a drop in pressure in the cockpit 13b when the cockpit door 15 is closed. The ambient air pressure sensor 22 may include dual sensing elements (not shown) for increased reliability. The ambient air pressure sensor 22 is in further communication with the control device 16. Generally, based upon the pressure reading taken by the ambient air pressure sensor 22, the control device 16 may signal the solenoid 20 to unlock the cockpit door 15. Such a condition might occur, for example, if the windshield of the aircraft 13 was broken. In such a situation, it would be necessary to immediately unlock the cockpit door 15 to allow passenger cabin air pressure to vent through the open cockpit door 15. The ambient air pressure sensor 22 is thus used to detect a drop in pressure within the cockpit 13b and to immediately signal this event by de-energizing the solenoid 20.

Referring to FIG. 2, a description will now be provided of the predetermined time delay sequence that is implemented by the controller 14. “T0” represents the instant that a user correctly enters the predetermined access code via the keypad 12. This code preferably comprises a three to eight digit numeric code. It is provided to flight attendants or other individuals, prior to entering the aircraft, who may have a need to periodically enter the cockpit 13b while the aircraft 13 is in operation. Immediately after receiving the correct access code, the controller 14 causes the chime 24 to generate an audible signal represented by pulses 52 and the “AUTO UNLK” indicator light 38 is continuously illuminated. Pulses 52 represent two “beeps” or other short duration audible signals which immediately apprises the individuals in the cockpit 13b that a request for access to the cockpit has just been made. At T0, a first predetermined delay interval is commenced which extends in to “T1”. At T1, if the controller 14 has not received either an UNLOCK or a DENY command via the switch 28 (i.e., the switch 28 has not been moved to either of these positions), then the controller causes the chime 24 to again provide audible signals, while the “AUTO UNLK” indicator light 38 remains continuously illuminated, represented by pulses 54, to remind the occupants of the cockpit 13b that someone is requesting access to the cockpit. T1 represents the expiration of the first delay interval and the beginning of a second delay interval.

At “T2”, if the switch 28 still has not been moved out of the AUTO position during the second delay interval, then the controller 14 causes a third delay interval to be commenced. At T2 the controller 14 causes the “AUTO UNLK” indicator light 38 to flash continuously and the chime 24 is caused to output a continuous audible alert, represented by waveform 56, that the door lock 26 of the cockpit door 15 will be unlocked within a very short time period if no operator action is taken via the switch 28. At any time, an occupant in the cockpit 13b may move the switch element 36 of the switch 28 to the UNLOCK position 32, which signals the controller 14 to turn off the chime 24 and the “AUTO UNLK” indicator light 38, as well as to command solenoid 20 to unlock the door lock 26. Also at any time during the first delay interval, the second delay interval or the third delay interval, an occupant in the cockpit 13b may move the switch element 36 to the DENY position 34. This signals the controller 14 to turn off the chime 24 and the “AUTO UNLK” indicator light 38, and further inhibits operation of the keypad 12 for a predetermined time thereafter. This predetermined time may vary but is preferably for a time interval of between five minutes to thirty minutes. During this time, if an individual should again correctly enter the access code into the keypad 12, no audible or visual signals would be provided by the chime 24 or “AUTO UNLK” indicator light 38. After the expiration of this time period, then the user may again input the access code into the keypad 12 and make another request to access the cockpit 13b.

At T3, as long as no operator selection has been made via the switch 28 (i.e., meaning that the switch element 36 has remained in the AUTO position 30), the controller 14 causes the solenoid 20 to be de-energized. This causes the door lock 26 to be unlocked. Thereafter, manual actuation of the door handle of the cockpit door 15 will allow the door to be opened.

In the preferred embodiment described above, the delay interval between T0 and T3 is user programmable from about 15 seconds to about 120 seconds in 15 second increments. Preferably, the delay interval between T2 and T3 has a minimum duration of at least 10 seconds. The audible signals represented by pulses 52 and 54 preferably comprise 0.5 second duration audible signals having a frequency of preferably around 500 Hz at approximately 85 to 93 dB. It will be appreciated, however, that the duration, frequency and intensity of these audible signals may be modified to suit user preferences.

The “AUTO UNLK” indicator light 38, when flashing during the third delay interval, preferably flashes at a 50% to 60% duty cycle, with 60% being the more preferred duty cycle. Again, however, the frequency at which this light flashes may be tailored to suit user preferences.

When the door lock 26 of the cockpit door 15 is unlocked at point T3, the door is preferably maintained in the unlocked position for a predetermined time interval, and more preferably for at least about five seconds. Again, this delay interval could also be modified. During this time period the solenoid 20 remains de-energized. After this short time interval expires, the controller 14 again automatically energizes the solenoid 20 to cause the door lock 26 to lock the cockpit door 15.

The access code and time delay settings are preferably changeable from the controller 14. The access code can be changed by engaging a “PROGRAM” key 58 on the controller 14 as indicated in FIG. 1. Once key 58 is depressed, a new access code can be entered at the keypad 12. The time delay settings may be modified by engaging a “PROGRAM” key 59 on the controller 14, as shown in FIG. 1. Similarly, once key 59 is depressed, new time settings may be entered via the keypad 12.

Another optional feature which may be implemented is a “door bell” mode. This mode may be implemented by selecting a particular key, such as the “1” key on the keypad 12, followed by the “ENTER” key 42a. This causes the chime 24 to generate an audible signal but does not begin the time delay period represented between T0 and T3. In effect, the occupants of the cockpit 13b are simply apprised that an individual in the cabin area 13a of the aircraft 13 is requesting access to the cockpit. The audible signal may comprise one or more short duration signals by the chime 24.

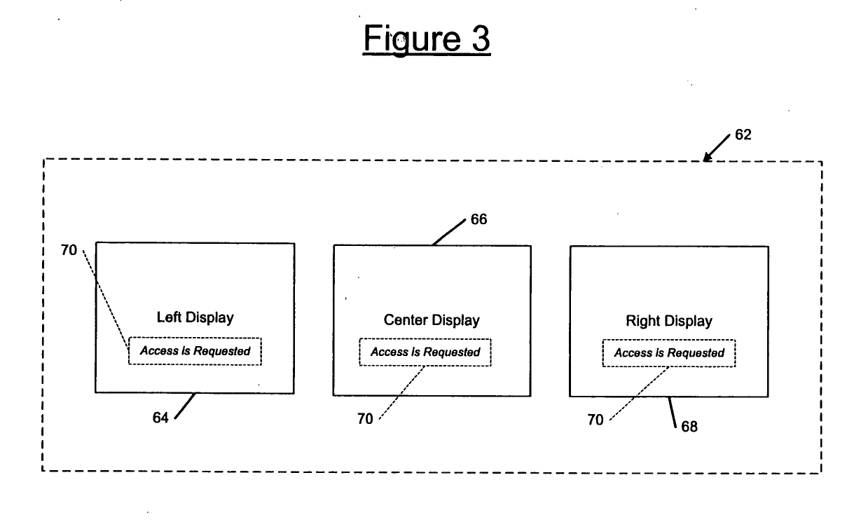

Alternatively, as shown in FIG. 3, the controller 14 may be in communication with a visual display system 62 in the cockpit 13b to indicate the status of the door lock 26. More specifically, the visual display system 62 aircraft may include three multifunction displays, a left display 64, a center display 66, and a right display 68. Of the three multifunction displays, the left display 64 is generally dedicated exclusively to the occupant seated in a left seat (not shown), the right display 68 is generally dedicated exclusively to the occupant seated in a right seat (not shown), and the center display 66 is typically shared by the both occupants. The controller 14 may send a signal to the visual display system 62 which provides a pop-up window 70 (shown in phantom) on the visual display system 62 to indicate that the door lock 26 is unlocked or that the door lock 26 has failed to unlock the cockpit door 15. The pop-up window 70 may be displayed on either the left display 64, right display 68 or center display 66, or on an any combination of displays, such as, for example, the left display 64 and right display 68. The pop-up window 70 may also be scrolled across each of the displays 64-68. The pop-up window 70 may further include any appropriate message, such as “Access is Requested” or the like. Thus, the pop-up window 70 provides immediate visual notification of the condition of the door lock 26 to the occupants of the cockpit 13b seated in front of the visual display system 62.

The system 10 of the present invention thus provides a means by which individuals in the cabin area of the aircraft can request access to the cockpit, and can further initiate a process by which a locked cockpit door will be automatically unlocked if no intervention is taken by occupants of the cockpit. The inclusion of the pressure sensor also ensures that in the event of a decompression condition occurring in the cockpit, the cockpit door will be automatically and immediately unlocked so that the door can be quickly opened. Importantly, the system 10 provides the occupants of the cockpit with the ultimate authority to deny the requested access if circumstances are such that the cockpit occupants believe that the cockpit should remain secure from all individuals in the cabin area.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

1. A security system for preventing unauthorized access to an area, through a lockable door defining an entry way into the area, said system comprising:
a lock for locking the door;
a user input device accessible by individuals seeking to gain access into the area to input a predetermined access code to request unlocking of the door;
a controller responsive to the user input device for producing a signal within the area when the access code is entered that entry to the area has been requested by an individual outside of the area;
a control device that is not accessible by an individual outside the area, and in communication with the lock for allowing an individual in the area to unlock the door; and
at least one cut-off switch operable to remove power to the lock.

2. The security system of claim 1, further comprising:
at least one pressure sensor in communication with the controller to transmit at least one pressure signal, the at least one pressure signal operable to cause the controller to immediately unlock the lock; and
wherein the at least one pressure sensor is operable to unlock the door regardless of the input from the user input device and the control device.

3. The security system of claim 1, wherein the at least one cut-off switch is mounted in the area.

4. The security system of claim 1, further comprising:
a display system in communication with the controller, the display system operable to display an indication in the control center that entry into the control center has been requested by an individual in the passenger area.

5. The security system of claim 4, wherein the display system further comprises at least one multi-function visual display, the at least one multi-function visual display operable to receive a signal from the controller to display at least one of a message and a visual indicator that access is being requested.

6. The security system of claim 5, wherein the at least one multi-function display includes a left multi-function display, a right multi-function display and a center multi-function display.

7. The security system of claim 6, wherein the at least one of the message and visual indicator are displayed on at least one of the left multi-function display, right multi-function display and center multi-function display.

8. The security system of claim 7, wherein the message includes a warning that entry into the control center is being requested.

9. The security system of claim 8, wherein the visual indicator further comprises a pop-up window or a flashing indicator.

10. The security system of claim 9, wherein the message scrolls across the at least one of the left multi-function display, right multi-function display and center multi-function display.

11. A security system for preventing unauthorized access to a control center of a mobile platform, wherein the control center is separated from a non-restricted area of said mobile platform by a door, said system comprising:
a lock for locking the door;
a user input device accessible by individuals in the non-restricted area to input a predetermined access code to request unlocking of the door;
a controller responsive to the user input device for producing a signal within the control center when the access code is entered that entry to the control center has been requested by an individual within the non-restricted area;
a control device within the control center in communication with the lock for allowing an individual in the control center to unlock the door; and
a display system in communication with the controller, the display system operable to display an indication in the control center that entry into the control center has been requested by an individual in the non-restricted area.

12. The security system of claim 11, wherein the display system further comprises at least one multi-function visual display, the at least one multi-function visual display operable to receive a signal from the controller to display at least one of a message and a visual indicator that access is being requested.

13. The security system of claim 12, wherein the at least one multi-function display includes a left multi-function display, a right multi-function display and a center multi-function display.

14. The security system of claim 13, wherein the at least one of the message and visual indicator are displayed on at least one of the left multi-function display, right multi-function display and center multi-function display.

15. The security system of claim 14, wherein the message includes a warning that entry into the control center is being requested.

16. The security system of claim 14, wherein the visual indicator further comprises a pop-up window or a flashing indicator.

17. A security system for preventing unauthorized access to a control center of a mobile platform, wherein the control center is separated from a non-restricted area of said mobile platform by a door; said system comprising:
a lock for locking the door;
a user input device accessible by individuals in the non-restricted area to input a predetermined access code to request unlocking of the door;
a controller responsive to the user input device for producing a signal within the control center when the access code is entered that entry to the control center has been requested by an individual within the non-restricted area;
a control device within the control center in communication with the lock for allowing an individual in the control center to unlock the door;
a display system in communication with the controller, the display system operable to display an indication in the control center that entry into the control center has been requested by an individual in the non-restricted area; and
wherein the display system further comprises at least one multi-function visual display, the at least one multi-function visual display operable to receive a signal from the controller to display at least one of a message and a visual indicator that access is being requested.

18. The security system of claim 17, wherein the at least one multi-function display includes a left multi-function display, a right multi-function display and a center multi-function display.

19. The security system of claim 18, wherein the at least one of the message and visual indicator are displayed on at least one of the left multi-function display, right multi-function display and center multi-function display.
